(19) United States
(12) Patent Application Publication
(10) Pub. No.: US 2017/0353428 A1
(43) Pub. Date: Dec. 7, 2017

(54) INFORMATION PROCESSING APPARATUS AND METHOD AND NON-TRANSITORY COMPUTER READABLE MEDIUM

(71) Applicant: FUJI XEROX CO., LTD., Tokyo (JP)

(72) Inventor: Kazumi YAMATO, Kanagawa (JP)

(73) Assignee: FUJI XEROX CO., LTD., Tokyo (JP)

(21) Appl. No.: 15/337,984

(22) Filed: Oct. 28, 2016

(30) Foreign Application Priority Data
Jun. 6, 2016 (JP) 2016-112841

(51) Int. Cl. H04L 29/12

(52) U.S. Cl. CPC H04L 61/2535; H04L 61/2007

(57) ABSTRACT

An information processing apparatus includes an obtaining unit, a trying unit, a specifying unit, and a connecting unit. The obtaining unit obtains addresses of individual devices in a network from the devices. The trying unit tries to communicate to the addresses of the devices via the network and stores trying results. The specifying unit specifies a device as a connecting device from among the devices. The connecting unit connects to the connecting device by using a connecting method which is specified based on the trying result concerning the connecting device.

### CROSS-REFERENCE TO RELATED APPLICATIONS

This application is based on and claims priority under 35 USC 119 from Japanese Patent Application No. 2016-112841 filed Jun. 6, 2016.

### BACKGROUND

### (i) Technical Field

The present invention relates to an information processing apparatus and method and a non-transitory computer readable medium.

### (ii) Related Art

Some devices, such as printers, have a function of receiving a processing instruction from a mobile terminal, such as a smartphone, carried by a user via an access point of a wireless local area network (LAN) or by performing direct wireless connection, such as Wi-Fi Direct (registered trademark), with the mobile terminal.

### SUMMARY

According to an aspect of the invention, there is provided an information processing apparatus including an obtaining unit, a trying unit, a specifying unit, and a connecting unit. The obtaining unit obtains addresses of individual devices in a network from the devices. The trying unit tries to communicate to the addresses of the devices via the network and stores trying results. The specifying unit specifies a device as a connecting device from among the devices. The connecting unit connects to the connecting device by using a connecting method which is specified based on the trying result concerning the connecting device.

### BRIEF DESCRIPTION OF THE DRAWINGS

An exemplary embodiment of the present invention will be described in detail based on the following figures, wherein:

FIG. 1 illustrates region 1 and region 2 set for a mobile terminal;

FIG. 2 illustrates an example of the functional configuration of a mobile terminal of an exemplary embodiment;

FIG. 3 illustrates an example of the data content in a device monitor database (DB);

FIG. 4 illustrates an example of the functional configuration of a device;

FIG. 5 illustrates an example of generic attribute profile (GATT) information concerning a device;

FIG. 6 is a flowchart illustrating an example of processing executed by the mobile terminal upon detecting a device in region 2;

FIGS. 7A, 7B, and 7C illustrate an example of the transition of the data content in the device monitor DB in accordance with the progress of the processing shown in FIG. 6;

FIG. 8 is a flowchart illustrating an example of processing executed by the mobile terminal upon detecting a device in region 1;

FIGS. 9A and 9B illustrate an example of the transition of the data content in the device monitor DB in accordance with the progress of the processing shown in FIG. 8;

FIG. 10 illustrates a specific example of a procedure for determining a connecting device in the exemplary embodiment;

FIG. 11 is a flowchart illustrating another example of processing executed by the mobile terminal upon detecting a device in region 1;

FIG. 12 illustrates an example of the data content in the device monitor DB in accordance with the processing shown in FIG. 11;

FIG. 13 illustrates examples of conditions for starting the mobile terminal and the content of processing executed in response to the conditions;

FIG. 14 illustrates the relationship of region A to regions 1 and 2;

FIG. 15 illustrates an example of a screen displayed on the mobile terminal for guiding the mobile terminal to a connecting device; and

FIG. 16 is a flowchart illustrating an example of processing for determining a connecting device in response to a specific operation.

### DETAILED DESCRIPTION

Usually, multifunction devices (having functions as a printer, a scanner, a copying machine, a fax machine, and so on) installed in a facility, such as an office or a store, are connected to a network such as a LAN provided in this facility. It is also common for a LAN in a facility to have a wireless access point (AP). A user may connect to a network in a facility via a wireless AP by using a mobile terminal of the user and control a device connected to the network to provide a print instruction, for example.

Direct wireless connection, such as Wi-Fi Direct (registered trademark), allows devices to directly communicate with each other, and more and more devices and terminals have this function. Quite a few devices and terminals also have Bluetooth (registered trademark) as another wireless connecting function. Nowadays, a power-saving Bluetooth technology called Bluetooth Low Energy (BLE) (registered trademark) is coming into a widespread use.

More and more devices, such as multifunction devices, are able to connect and communicate with user terminals (such as mobile terminals) by using plural connecting methods including, not only a method using a network such as a LAN, but also direct wireless connection such as Wi-Fi Direct and BLE.

There may be a situation where a user holding a mobile terminal approaches a device installed in a facility, and then connects to the device by using the mobile terminal via a network (via a wireless AP) or by performing direct wireless connection, such as Wi-Fi Direct, so as to provide an instruction to the device. In the following exemplary embodiment, connection control performed in this situation will be discussed below.

### Example of System Configuration

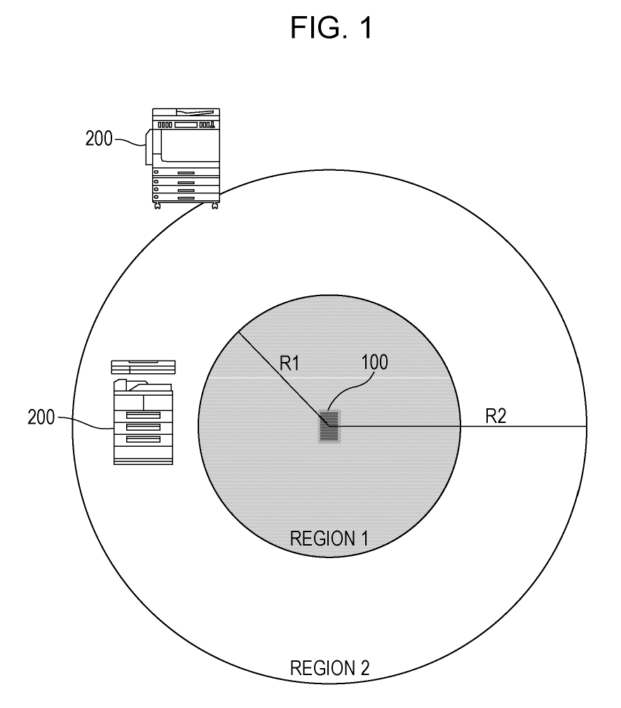

In this exemplary embodiment, as shown in FIG. 1, the distance between a mobile terminal 100 of a user and each device 200 is estimated by using, for example, a BLE distance estimating function. The mobile terminal 100 and the devices 200 have a BLE function.

As shown in FIG. 1, two distance regions, that is, a region 1 and a region 2, are defined in order in which they are closer to the mobile terminal 100. The region 1 is a circular region with a radius R1 formed around the mobile terminal 100. The region 2 is a donut-shaped region. If the region 1 is removed from a circular region with a radius R2 (R2>R1) formed around the mobile terminal 100, the resulting region is the region 2. The region 1 is positioned farther inward than the region 2, as viewed from the mobile terminal 100. In this exemplary embodiment, the BLE distance estimating function determines whether each device 200 is located within the region 1 or the region 2 or outside the region 2. The distance estimated by the BLE distance estimating function may vary depending on the radio wave environments and is not necessarily the same as the precise distance measured by optical measuring instruments or measuring tape. However, such a distance is still sufficient for a practical use as a rough measurement.

The radius R1 of the region 1 is set to be such a length as to allow a user separated from the device 200 by the radius R1 to start processing for direct wireless connection between the mobile terminal 100 and a device 200 and to finish processing before reaching the device 200. Specifically, the radius R1 is about one to five meters. The radius R2 of the region 2 is set to be greater than the radius R1 and is ten to some dozen meters, for example. The radius R2 is set to be such a length as to allow a user separated from the device 200 by the radius R2 to start processing to check whether the device 200 is reachable from the mobile terminal 100 via a network and to finish processing before reaching a position separated from the device 200 by the radius R1 (region 1). Instead of setting the radius R2 of the region 2 as discussed above, when the mobile terminal 100 successfully establishes BLE communication with the device 200, the device 200 may be determined to be located within the region 2.

In this exemplary embodiment, upon detecting a new device 200 within the region R2, the mobile terminal 100 checks the network reachability from the mobile terminal 100 to the device 200. The network reachability indicates whether the mobile terminal 100 can reach the device 200 via a network (for example, a LAN) in the facility in which the device 200 is installed. The mobile terminal 100 may check the network reachability by determining whether a response to a ping command packet sent from the mobile terminal 100 is returned from the device 200. The mobile terminal 100 records the result of checking the network reachability. Then, if the checking result indicates that the mobile terminal 100 is unable to reach the device 200 via a network, the mobile terminal 100 communicates with the device 200 which has entered the region 1 by using direct wireless connection, such as Wi-Fi Direct. When the device 200 enters the region 1, the result of checking the network reachability is already stored in the mobile terminal 100. Thus, if the device 200 does not have the network reachability, the mobile terminal 100 can immediately start processing for establishing direct wireless connection with the device 200 at a timing at which the device 200 enters the region 1.

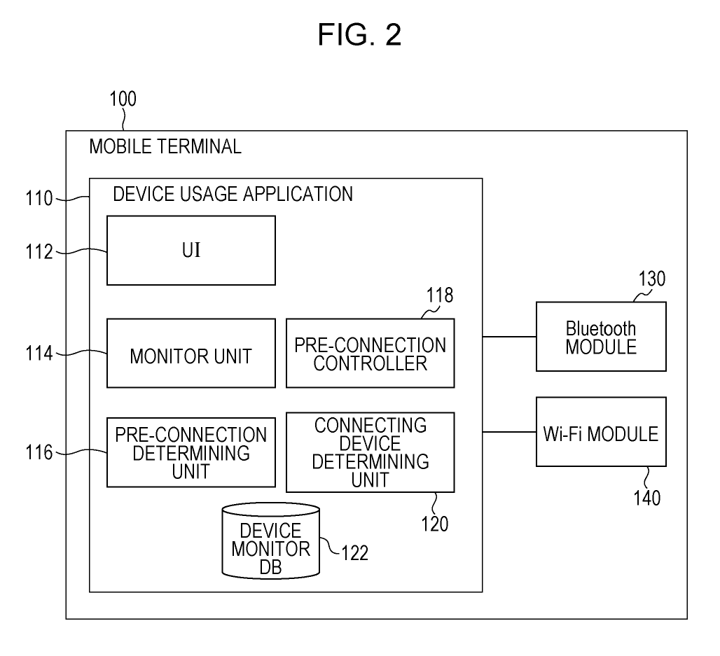

The functional configuration of the mobile terminal 100 will be described below with reference to FIG. 2.

The mobile terminal 100 is a mobile information processing apparatus, such as a smartphone and a tablet terminal. As shown in FIG. 2, the mobile terminal 100 includes a device usage application 110, a Bluetooth module 130, and a Wi-Fi module 140. The device usage application 100 is an application for executing various control operations for using devices 200. The device usage application 100 is implemented as a result of a computer built in the mobile terminal 100 executing a program representing the functions of the device usage application 100. The functions of the device usage application 100 will be discussed later. As the computer built in the mobile terminal 100, a Neumann computer is used.

The Bluetooth module 130 is a device that performs wireless communication compliant with the Bluetooth standards, and includes a hardware circuit and software for performing this wireless communication. In this exemplary embodiment, the Bluetooth module 130 supports BLE and has a distance estimating function. This distance estimating function estimates the relative distance of a device 200 to the mobile terminal 100, based on distance estimating information included in an advertising packet which is regularly sent from a Bluetooth module 210 (discussed later) of the device 200 and based on the received radio wave strength of the advertising packet. The distance estimating information is represented by, for example, a table indicating the distance according to the received radio wave strength.

The Wi-Fi module 140 is a device that performs wireless LAN communication compliant with the Wi-Fi standards, and includes a hardware circuit and software for performing this wireless LAN communication. The Wi-Fi module 140 has a wireless connecting function that enables the mobile terminal 100 to wirelessly connect to a network within a facility via a wireless AP in an infrastructure mode. The Wi-Fi module 140 may also support direct wireless connection with a partner device in an ad hoc (AdHoc) mode. The Wi-Fi module 140 may also support direct wireless connection with a partner device by using Wi-Fi Direct.

Details of the device usage application 110 will be discussed below.

The device usage application 110 includes a user interface (UI) 112, a monitor unit 114, a pre-connection determining unit 116, a pre-connection controller 118, and a connecting device determining unit 120.

The UI 112 performs user interface processing for controlling a device 200. For example, the UI 112 displays a menu screen for allowing the user to select one of the functions (such as printing, scanning, and fax sending) provided by the device 200 and a screen for allowing the user to input processing parameters (such as a document to be printed, print copies, scanning-result data format, and destination fax number) for the selected function, and receives the selection and input from the user. In this exemplary embodiment, plural devices 200 installed in a facility support the same UI functions provided by the UI 112. This enables the user to select a function and to input processing parameters by using the UI 112 before the device 200 to be used is selected. When the device 200 to be used is selected, the UI 112 supplies a processing instruction reflecting the selected function and the input processing parameters to the device 200 via a network within the facility or by direct wireless connection.

The monitor unit 114 monitors whether the relative distance of each device 200 to the mobile terminal 100 is within the region 2 or the region 1 or outside the region 2. The monitor unit 114 monitors the distance of each device 200, based on the relative distance of each device 200 to the mobile terminal 100 estimated by the Bluetooth module 130 using the BLE distance estimating function.

When the monitor unit 114 detects a new device 200 within the region R2, the pre-connection determining unit 116 determines the network reachability from the mobile terminal 100 to the device 200. The pre-connection determining unit 116 determines the network reachability by sending a ping command packet to an Internet protocol (IP) address contained in a BLE advertising packet received from the device 200. If a response to the ping command packet is returned from the device 200, the pre-connection determining unit 116 determines that the device 200 is reachable from the mobile terminal 100. If a response is not returned from the device 200 after the lapse of a predetermined timeout period (for example, one to several seconds), the pre-connection determining unit 116 determines that the device 200 is unreachable from the mobile terminal 100. If the device 200 is not connected to a network within the facility or if the mobile terminal 100 is not connected to the wireless AP of the network in the infrastructure mode, the pre-connection determining unit 116 determines that the device 200 is unreachable. The pre-connection determining unit 116 registers the determination result in a device monitor database (DB) 122.

The pre-connection controller 118 performs processing for connecting to a device 200 selected by the connecting device determining unit 120 from among the devices 200 within the region 1. For example, the pre-connection controller 118 establishes direct wireless connection with the selected device 200 by using Wi-Fi Direct if the selected device 200 is unreachable from the mobile terminal 100. If the selected device 200 is reachable from the mobile terminal 100, the mobile terminal 100 can communicate with the device 200 via a network, and it is not necessary to establish direct wireless connection with the device 200.

The connecting device determining unit 120 selects a device 200 to be connected to the mobile terminal 100 (hereinafter such a device may also be called a connecting device) from among the devices 200 within the region 1.

The connecting device determining unit 120 may select the device 200 located closest to the mobile terminal 100 (hereinafter such a device may also be called a closest distance device) as the connecting device from among the devices 200 within the region 1.

The connecting device determining unit 120 may select a device 200 as the connecting device by reflecting the capabilities of each of the devices 200 within the region 1. As discussed above, the UI 112 can receive the selection of a function and input of processing parameters before a connecting device 200 is selected. This enables the connecting device determining unit 120 to select as the connecting device a device 200 that can execute the function and processing parameters input into the UI 112 from among the devices 200 within the region 1.

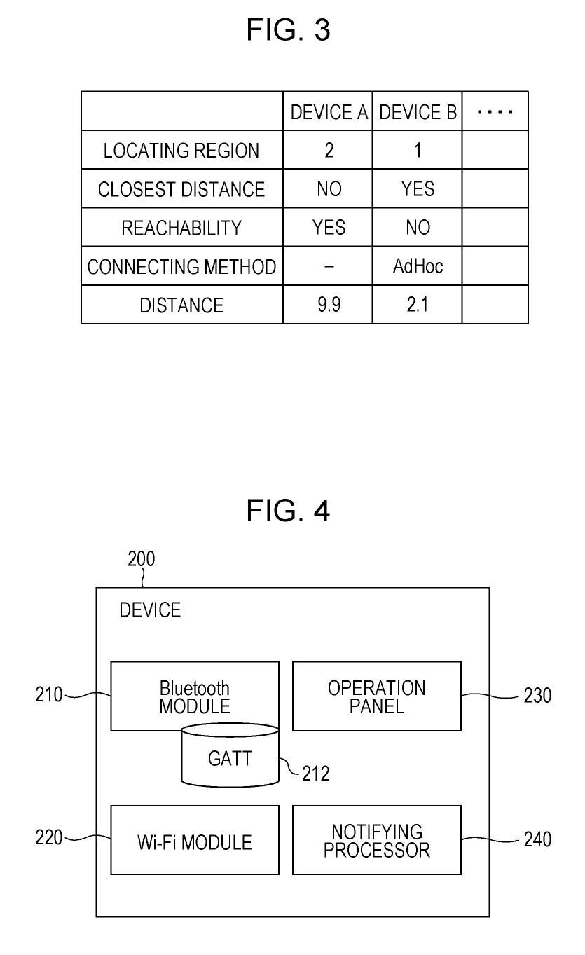

The device monitor DB 122 is a database that stores and manages information for controlling communication connection concerning each device 200 detected by the monitor unit 114. An example of data registered in the device monitor DB 122 is shown in FIG. 3. In this example, in the device monitor DB 122, various items of information concerning a locating region, a closest distance flag, a reachability flag, a connecting method, and a distance are registered for each device 200 in association with identification information concerning the corresponding device 200 (for example, the IP address of the device 200 received from the device 200 by BLE).

The field “locating region” indicates in which one of the region 1 or the region 2 the device 200 is located. If the device 200 extends to outside the region 2, information concerning the device 200 is deleted from the device monitor DB 122. Alternatively, even if the device 200 extends to outside the region 2, information concerning the device 200 (for example, the reachability and the connecting method) may remain in the device monitor DB 122 for a certain period. In this case, in the locating region, the value representing whether the device 200 is within the region 1 or the region 2 or outside the region 2 is registered.

The closest distance flag indicates whether the device 200 is located closest to the mobile terminal 100. In the example shown in FIG. 3, a device B is the device 200 located closest to the mobile terminal 100. The closest distance device 200 is specified from among the devices 200 located within the region 1.

The reachability flag indicates the network reachability from the mobile terminal 100 to the device 200, that is, whether the device 200 is reachable from the mobile terminal 100 (whether the mobile terminal 100 can communicate with the device 200) via a network within the facility. In the reachability flag, the value representing the result of determining the reachability by the pre-connection determining unit 116 is set. In the example shown in FIG. 3, a device A is reachable from the mobile terminal 100 via a network, while the device B is unreachable.

The field “connecting method” indicates identification information concerning the connecting method used by the mobile terminal 100 for performing direct wireless connection with the device 200. This exemplary embodiment is based on the condition that each device 200 has a BLE direct wireless connecting function. The devices 200 may also support other direct wireless connecting methods such as Wi-Fi ad hoc connection and Wi-Fi Direct. When performing direct wireless connection with a device 200, the mobile terminal 100 sequentially tries one or more direct wireless connecting methods supported by the device 200, and communicates with the device 200 by using the direct wireless connecting method by which connection is first established. Identification information concerning the established direct wireless connecting method is registered in the field “connecting method”.

The field “distance” indicates the distance estimated by the Bluetooth module 130 using the BLE distance estimating function, that is, the estimated distance from the mobile terminal 100 to the device 200.

The functions related to the connection control performed in this exemplary embodiment among the functions of the device usage application 110 have been discussed above. In addition to the above-described functions, the device usage application 110 has various other functions for using the devices 200, such as a function of sending instructions and control parameters input into the UI 112 by a user to the device 200. However, such functions are similar to those of the related art, and an explanation thereof will thus be omitted.

An example of the functional configuration of the device 200 will be described below with reference to FIG. 4. FIG. 4 shows the functions of the device 200 related to the connection control performed in this exemplary embodiment. In addition to the function modules shown in FIG. 4, the device 200 has various other function modules, such as a function module for executing service functions (for example, printing and scanning) provided to a user by the device 200 and a function module for controlling a UI and the entire device 200. Such function modules are similar to those of the related art, and an explanation thereof will thus be omitted.

The device 200 shown in FIG. 4 includes a Bluetooth module 210, a Wi-Fi module 220, an operation panel 230, and a notifying processor 240.

The Bluetooth module 210 is a device that performs wireless communication compliant with the Bluetooth standards, and includes a hardware circuit and software for performing this wireless communication. In this exemplary embodiment, the Bluetooth module 210 supports BLE and has a function of regularly sending an advertising packet. That is, the Bluetooth module 210 serves as a BLE peripheral. The advertising packet includes the above-described distance estimating information used for estimating the distance from the mobile terminal 100 to the device 200 and information concerning the IP address of the device 200 in a network within the facility. The Bluetooth module 210 manages BLE profile information called a generic attribute profile (GATT) 212, and has a function of supplying GATT information in response to a request from a BLE communication party (for example, the mobile terminal 100).

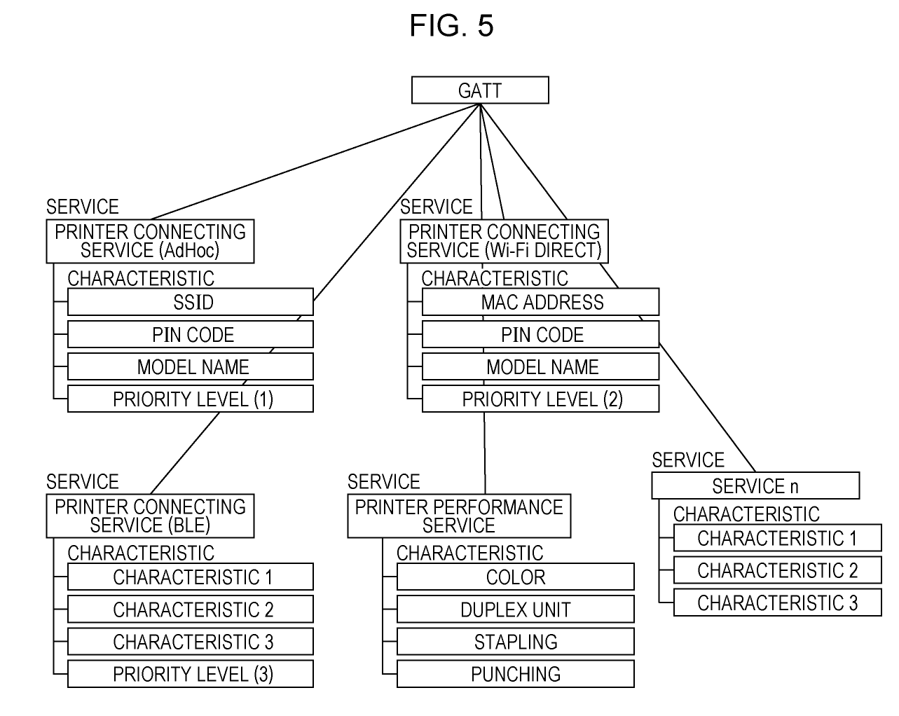

FIG. 5 illustrates an example of the data structure of the GATT 212 managed by the Bluetooth module 210. The example shown in FIG. 5 is a GATT profile concerning the device 200 serving as a printer. As shown in FIG. 5, the GATT profile for the device 200 includes information concerning various services provided by the Bluetooth module 210 to BLE communication parties (for example, the mobile terminal 100). In this exemplary embodiment, the services provided by the Bluetooth module 210 to BLE communication parties include a service (“printer connecting service”) for providing information necessary for performing a direct wireless connecting method supported by the device 200 and a service (“printer performance service”) for providing information concerning the capabilities (performance) of the device 200 (printer). If the device 200 supports plural direct wireless connecting methods, these individual direct wireless connecting methods are defined by different printer connecting services. The example in FIG. 5 shows that the device 200 supports three direct wireless connecting methods, that is, ad hoc mode, Wi-Fi Direct, and BLE.

Information concerning an individual service includes a universally unique identifier (UUID), which is identification information concerning this service, and 0 or more characteristics, which are various items of user data for this service. Each characteristic includes the UUID and the value of this characteristic. For example, “printer connecting service (AdHoc)” for providing information concerning Wi-Fi connection in the ad hoc mode includes three characteristics necessary for ad hoc connection such as a service set identifier (SSID), a personal identification number (PIN) code, and a model name. This service (“printer connecting service (AdHoc)”) also includes a characteristic indicating the priority level of this connecting method (ad hoc mode) among the three direct wireless connecting methods supported by the device 200. The priority levels of the direct wireless connecting methods are decided by the administrator of the device 200, for example, by considering the communication rate of each connecting method. In “printer performance service”, characteristics such as “color” indicating whether the device 200 supports full-color printing, “duplex unit” indicating whether a duplex printing unit is provided, “stapling” indicating whether a stapling function is provided, and “punching” indicating whether a punching function is provided are included. If the device 200 is a multifunction device, the GATT profile includes information concerning other device functions such as “scanner performance service” and “fax machine performance service”, as well as “printer performance service”.

Referring back to FIG. 4, the Wi-Fi module 220 is a device that performs wireless LAN communication compliant with the Wi-Fi standards, and includes a hardware circuit and software for performing this wireless LAN communication. If the device 200 is wirelessly connected to a network within the facility via a wireless AP, the Wi-Fi module 220 has a wireless connecting function in the infrastructure mode. The device 200 may be connected to a network within the facility by a wired medium. The Wi-Fi module 220 may support the ad hoc (AdHoc) mode or Wi-Fi Direct, or both of them.

The operation panel 230 is a display panel that displays a UI screen used by the user to operate the device 200. On the operation panel 230, various screens provided by a multifunction device, such as a menu screen and an input screen for processing parameters, are displayed. If the device 200 is selected as a connecting device to be accessed from the mobile terminal 100, the operation panel 230 displays this information in a special manner for the user. For example, the screen of the operation panel 230 may be caused to blink, or a message indicating that the device 200 is selected as a connecting device may be displayed on the screen of the operation panel 230. For example, a message “Mr. A (the owner name of the mobile terminal 100), printing is starting,” may be displayed.

If the device 200 is selected as a connecting device to be accessed from the mobile terminal 100, the notifying processor 240 performs processing for supplying this information to the user. The information may be supplied in a special manner, for example, the screen of the operation panel 230 may be caused to blink. Alternatively, sound may be output from a speaker (not shown) of the device 200.

### Processing Executed upon Device Entering Region 2

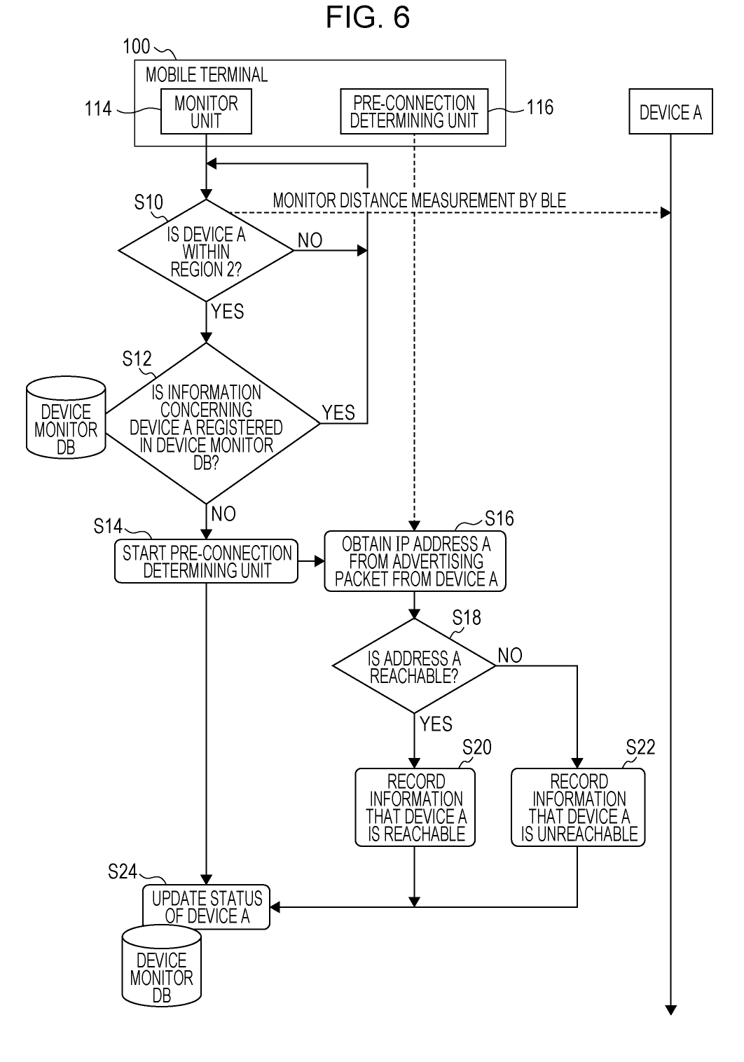

A description will be given below, with reference to FIG. 6, of a processing procedure executed by the mobile terminal 100 upon detecting that a device 200 has entered the region 2 (outer region, see FIG. 1).

The Bluetooth module 130 receives an advertising packet regularly sent from each device 200 and estimates the distance of each device 200 by using information included in the advertising packet. Information concerning the estimated distance of each device 200 is supplied to the monitor unit 114. FIG. 6 is a flowchart illustrating processing executed by the mobile terminal 100 upon receiving an advertising packet from a device A. The mobile terminal 100 executes the processing shown in FIG. 6 for each device 200 from which an advertising packet is received.

In step S10, the monitor unit 114 determines whether the device A is located within the region 2, based on information indicating the estimated distance of the device A received from the Bluetooth module 130. If the estimated distance of the device A ranges from R1 to R2 (see FIG. 1), the result of step S10 is YES, and the process proceeds to step S12. If the result of step S10 is NO, the monitor unit 114 waits for receiving the next advertising packet from the device A and makes a determination in step S10 again.

In step S12, the monitor unit 114 determines whether information concerning the device A is registered in the device monitor DB 122. If information concerning the device A is already registered in the device monitor DB 122, the monitor unit 114 updates the value of the distance of the device A within the device monitor DB 122 to that estimated by the Bluetooth module 130, and waits for receiving the next advertising packet from the device A.

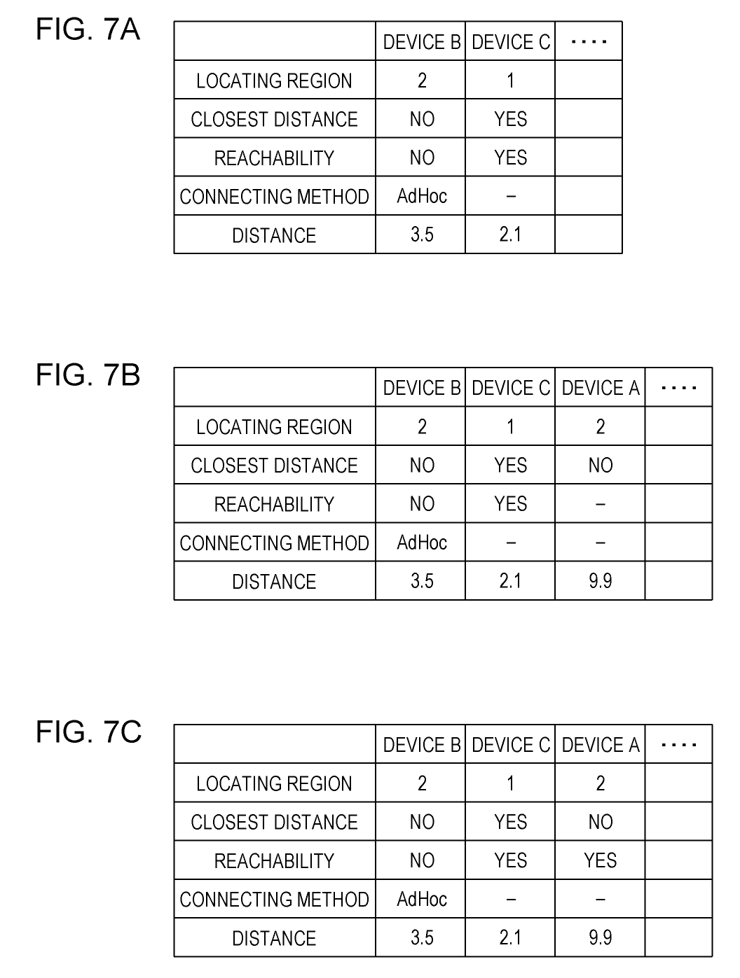

If it is determined in step S12 that information concerning the device A is not registered in the device monitor DB 122, the monitor unit 114 creates an entry for the device A in the device monitor DB 122. In this entry, “2” (region 2) is input into the locating region, “NO” is input into the closest distance flag, and the distance estimated by the Bluetooth module 130 is input into the distance. The reachability flag and the connecting method are still undefined. If the data content in the device monitor DB 122 immediately before it is detected in step S10 that the device A has entered the region 2 is represented by that shown in FIG. 7A, the data content in the device monitor DB 122 when new data is registered in the entry for the device A in step S12 may be represented by that shown in FIG. 7B. Then, in step S14, the monitor unit 114 starts the pre-connection determining unit 116 and requests it to check the network reachability of the device A.

In step S16, the pre-connection determining unit 116 obtains the IP address of the device A from an advertising packet sent from the device A, and sends a ping command by using the IP address as a destination. Then, in step S18, the pre-connection determining unit 116 determines whether this IP address has network reachability. If a response to the ping command is returned before the lapse of a predetermined timeout period, the pre-connection determining unit 116 determines that the device A is reachable. In step S20, the pre-connection determining unit 116 registers information that the device A is reachable in the device monitor DB 122. If a response to the ping command is not returned after the lapse of the predetermined timeout period, the pre-connection determining unit 116 determines in step S18 that the device A is unreachable. In step S22, the pre-connection determining unit 116 registers information that the device A is unreachable in the device monitor DB 122. In step S24, the data content in the device monitor DB 122 is updated to that reflecting the information concerning the reachability of the device A. If the data content in the device monitor DB 122 immediately after step S12 is represented by that shown in FIG. 7B and if the device A is determined to be reachable in step S18, the data content in the device monitor DB 122 after the data is updated in step S24 is represented by that shown in FIG. 7C.

### Processing Executed upon Device Entering Region 1

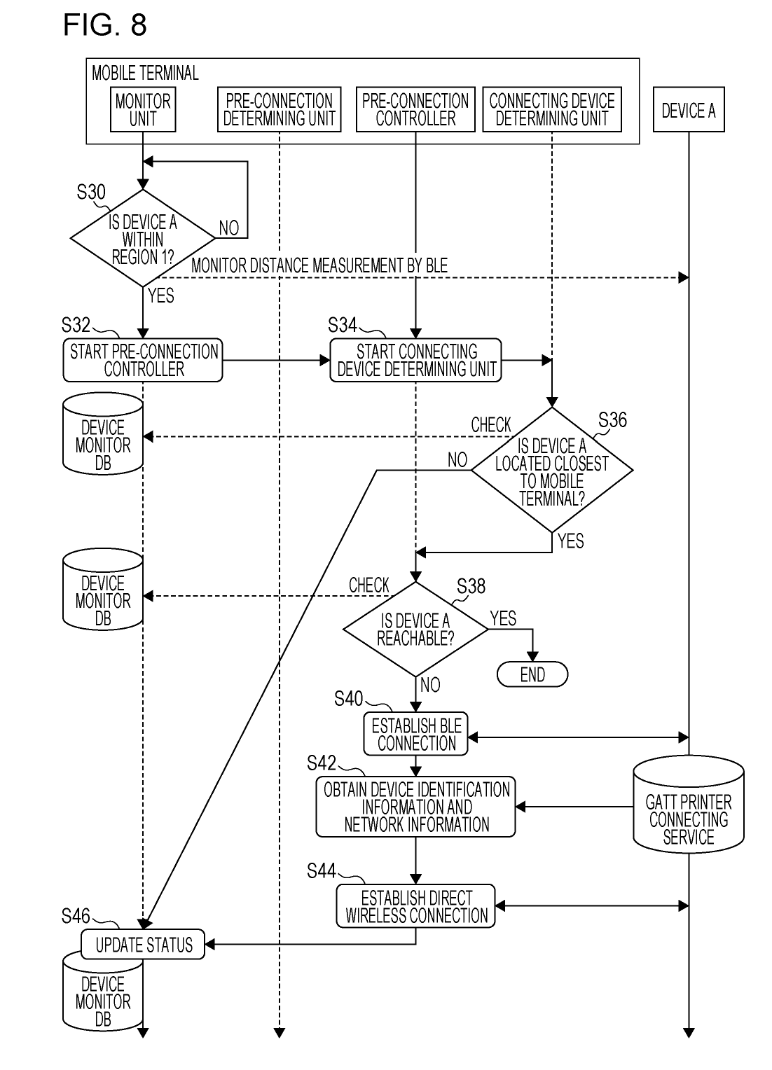

A description will be given below, with reference to FIG. 8, of a processing procedure executed by the mobile terminal 100 upon detecting that a device 200 has entered the region 1 (inner region, see FIG. 1).

In step S30, the monitor unit 114 determines whether a device A is located within the region 1, based on information concerning the estimated distance of the device A received from the Bluetooth module 130. If the estimated distance of the device A is R1 or smaller (see FIG. 1), the result of step S30 is YES, and the process proceeds to step S32. If the result of step S30 is NO, the monitor unit 114 waits for receiving the next advertising packet from the device A and makes a determination in step S30 again.

In step S32, the monitor unit 114 starts the pre-connection controller 118 and requests it to perform connection control of the device A determined to be located within the region 1 in step S30. In step S34, the pre-connection controller 118 starts the connecting device determining unit 120 and requests it to determine whether the device A will be selected as a connecting device. In this example, the connecting device determining unit 120 selects the device located closest to the mobile terminal 100 as a connecting device. The connecting device determining unit 120 determines in step S36 whether the device A is located closest to the mobile terminal 100. If the distance of the device A detected in step S30 is smaller than the distances of any devices located within the region (values in the locating region in the device monitor DB 122 for such devices indicate “1”), the result of step S36 is YES. If the device A is the only device within the region 1, the result of step S36 is YES.

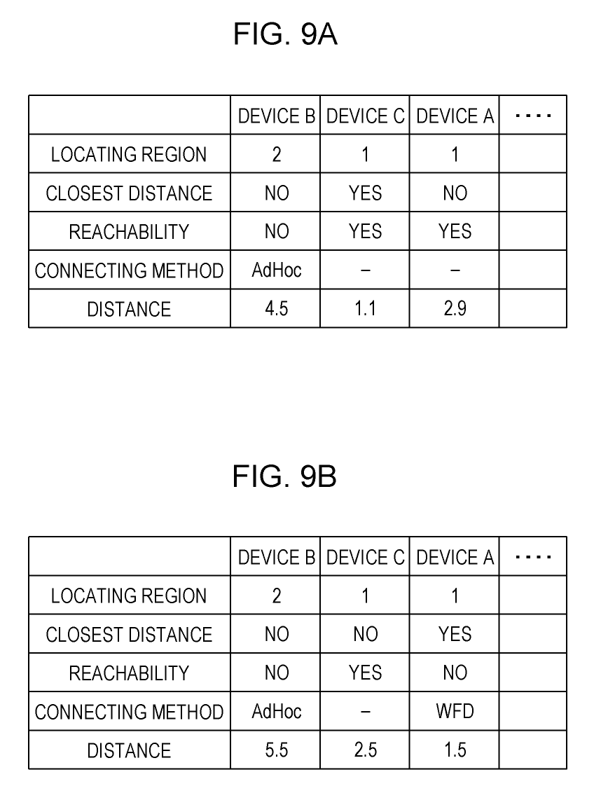

If the result of step S36 is NO, the process proceeds to step S46. In step S46, the connecting device determining unit 120 updates information concerning the device A in the device monitor DB 122 in accordance with the result detected in step S30. The data content in the device monitor DB 122 after step S46 may be represented by that shown in FIG. 9A. In this example, a device C is located closest to the mobile terminal 100 and is selected as a connecting device. The device A is not selected as a connecting device. In the example shown in FIG. 9A, the closest distance device C is reachable from the mobile terminal 100 via a network and direct wireless connection is not necessary. Thus, the field of the connecting method is blank.

If the result of step S36 is YES, the pre-connection controller 118 selects the closest distance device A as a connecting device. In the processing shown in FIG. 8, the device 200 that enters the region 1 first (that is, there is no other device in the region 1) is always specified as a connecting device. Then, if another device 200 also enters the region 1 and if this device 200 is located closest to the mobile terminal 100, the connecting device is switched to this device 200.

If the device A is found to be the closest distance device in step S36, the pre-connection controller 118 obtains the value of the reachability flag concerning the device A from the device monitor DB 122, and determines in step S38 whether the value indicates YES (reachable). If the device A is reachable, the mobile terminal 100 can communicate with the device A via a network in the facility by using the infrastructure connecting function of the Wi-Fi module 220, and does not have to establish direct wireless connection with the device A. Thus, the pre-connection controller 118 terminates the processing.

If the result of step S38 is NO (unreachable), the pre-connection controller 118 executes processing for establishing direct wireless connection with the device A selected as a connecting device. In step S40, the pre-connection controller 118 first performs BLE communication with the device A by using the Bluetooth module 130. Then, in step S42, the pre-connection controller 118 obtains a profile of a printer connecting service (see FIG. 5) from the GATT 212 of the device A. If the device A supports plural printer connecting services, the pre-connection controller 118 obtains profiles of these plural printer connecting services. The obtained profile includes device identification information (such as SSID or MAC address) and network information (such as PIN code) for establishing direct wireless connection.

In step S44, the pre-connection controller 118 tries the connecting methods indicated in the obtained printer connecting services in order of priority to establish direct wireless connection. In the example shown in FIG. 5, the pre-connection controller 118 first tries Wi-Fi ad hoc connection at the highest priority level, and if connection fails, the pre-connection controller 118 tries Wi-Fi Direct connection at the second highest priority level. If connection fails, the pre-connection controller 118 communicates with the device A by BLE. BLE communication connection has already been established in step S40, and even if ad hoc connection or Wi-Fi Direct connection of a higher communication rate fails, the mobile terminal 100 and the device A can send and receive data by BLE.

Then, in step S46, identification information concerning the direct wireless connecting method established in step S44 is registered in the field “connecting method” in the device monitor DB 122. If Wi-Fi Direct connection with the device A is successfully established, the data content in the device monitor DB 122 may be represented by that shown in FIG. 9B. In this example, the device A is the closest distance device within the region 1 and does not have network reachability. The mobile terminal 100 thus tries direct wireless connection, and as a result, Wi-Fi Direct (WFD) connection has been established.

If the monitor unit 114 detects that a device 200 has extended to outside the region 1 where the mobile terminal 100 is performing direct wireless connection, the pre-connection controller 118 disconnects this direct wireless connection (and BLE connection if it is performed).

There may be a situation where after the device 200 has extended to outside the region 1 and the pre-connection controller 118 has disconnected direct wireless connection, the device 200 enters the region 1 again and is located closest to the mobile terminal 100. In this case, the pre-connection controller 118 may reestablish direct wireless connection by using the connecting method (ad hoc connection for the device B in FIGS. 9A and 9B) stored in the device monitor DB 122. When the pre-connection controller 118 reestablishes direct wireless connection, it may omit to try the connecting methods of the other printer connecting services of higher priority levels than the connecting method indicated in the GATT information obtained by BLE connection. This increases the connecting speed. Alternatively, the pre-connection controller 118 may even omit to obtain the GATT information from the device 200 or to establish BLE connection with the device 200, and reconnect to the device 200 by using information concerning the connecting method stored in the device monitor DB 122.

As a result of executing processing discussed with reference to FIGS. 6 and 8, the mobile terminal 100 connects to the device 200 located closest to the mobile terminal 100 in the region 1 via a network or by any direct wireless connection. Then, the user can provide a processing instruction, for example, to the device 200 by using the mobile terminal 100.

### Specific Example of Procedure for Determining Connecting Device

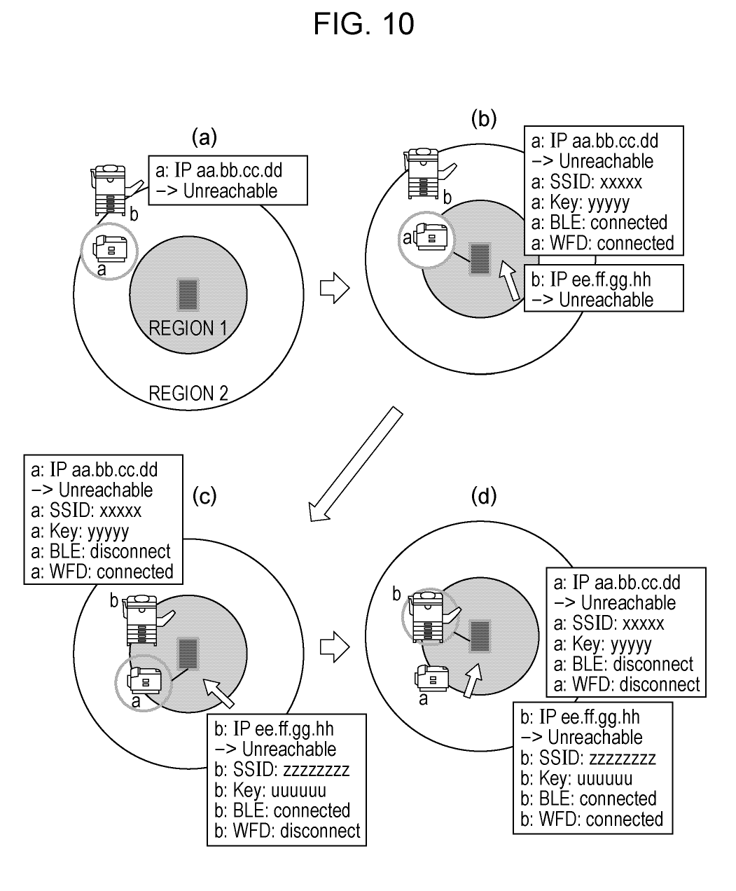

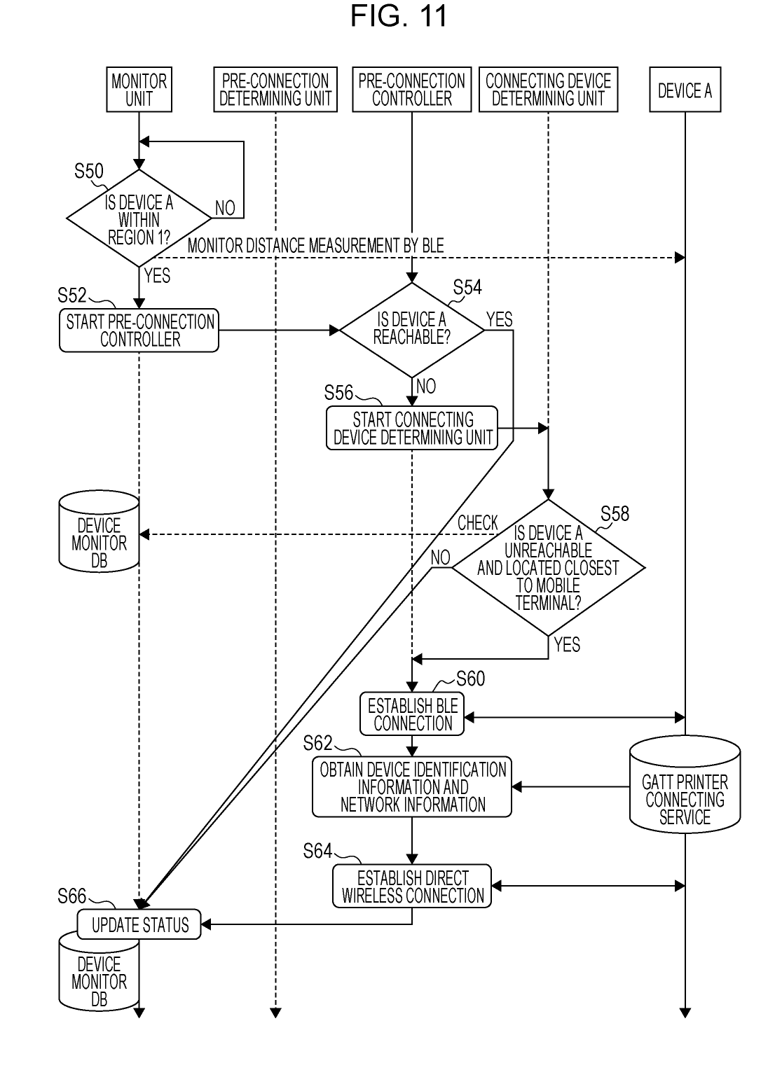

A specific example of a procedure for determining a connecting device in this exemplary embodiment will be described below with reference to FIG. 10.

A user (mobile terminal 100) is approaching two devices (printers) a and b. At a time point in (a) of FIG. 10, the device a enters the region 2, while the device b is outside the region 2. The pre-connection determining unit 116 obtains the IP address “aa.bb.cc.dd” from an advertising packet received from the device a and sends a ping command to the IP address so as to determine whether the IP address is reachable. In this example, the pre-connection determining unit 116 determines that the IP address “aa.bb.cc.dd” of the device a is unreachable, and registers this information in the device monitor DB 122.

After a while, at a time point in (b) of FIG. 10, the device a enters the region 1 and the device b enters the region 2. At this time, the device a is located closest to the mobile terminal 100 in the region 1 and is thus selected as a connecting device. The mobile terminal 100 establishes BLE connection with the device a so as to obtain GATT information, and then establishes direct wireless connection with the device a by using information concerning a printer connecting service included in the GATT information. In this example, Wi-Fi Direct connection is established. At this time point, the mobile terminal 100 is connecting to the device a by BLE and Wi-Fi Direct (“connected”). Regarding the device b, the pre-connection determining unit 116 checks the reachability to the IP address “ee.ff.gg.hh” obtained from an advertising packet, and determines that this IP address of the device b is unreachable.

Then, the user moves, and at a time point in (c) of FIG. 10, the device b enters the region 1 and is located closest to the mobile terminal 100. At this time point, the mobile terminal 100 is still connecting to the previous closest distance device a by Wi-Fi Direct. To switch the connecting device to the current closest distance device b, the mobile terminal 100 disconnects BLE connection with the device a (“disconnect”) and establishes BLE connection with the device b (“connected”) to obtain GATT information.

The mobile terminal 100 then disconnects Wi-Fi Direct connection with the device a, and establishes direct wireless connection with the device b by using information concerning a printer connecting service included in the GATT information concerning the device b. In this example, the mobile terminal 100 establishes Wi-Fi Direct connection with the device b. The connection state of the mobile terminal 100 with the device a and the device b is indicated by (d) of FIG. 10. In this example, the mobile terminal 100 can connect to only one device 200 by ad hoc connection or Wi-Fi Direct connection, and thus switches the connecting device as described above.

### Summary of Exemplary Embodiment

In the above-described exemplary embodiment, when a device 200 enters the region 2, the mobile terminal 100 checks the network reachability from the mobile terminal 100 to this device 200, and records the checking result in the device monitor DB 122. When the device 200 enters the region 1 afterwards, the checking result of the network reachability is already stored in the device monitor DB 122. If the device 200 does not have the network reachability, the mobile terminal 100 can immediately start processing for establishing direct wireless connection with the device 200 when the device 200 enters the region 1. If there are other devices 200 within the region 1, the mobile terminal 100 can immediately start processing for establishing direct wireless connection with this device 200 when the device 200 is located closest to the mobile terminal 100.

When the user reaches the device 200, direct wireless connection has already been established, or processing for establishing direct wireless connection has partially finished. The user does not have to wait a long time before the mobile terminal 100 starts to control the device 200 by direct wireless connection. In contrast, if the mobile terminal 100 starts processing for establishing direct wireless connection after the user reaches the device 200 as a result of the user tapping the mobile terminal 100 on the device 200 to send and receive network information by near field communication (NFC), the user has to wait a longer time before the mobile terminal starts to control the device 200.

### Another Example of Processing Executed upon Device Entering Region 1

A description will be given below, with reference to FIG. 11, of another example of a processing procedure executed by the mobile terminal 100 upon detecting that a device 200 has entered the region 1.

In the example shown in FIG. 8, if a first device 200 located closest to the mobile terminal 100 is reachable, it is selected as a connecting device, and if a second device 200 located second closest to the mobile terminal 100 in the region 1 is unreachable, the mobile terminal 100 does not establish direct wireless connection with the second device 200. In the example shown in FIG. 11, the mobile terminal 100 establishes direct wireless connection with the second device 200. That is, in this example, the mobile terminal 100 establishes direct wireless connection with the device 200 located closest to the mobile terminal 100 among unreachable devices 200 within the region 1. With this configuration, when the user decides to use this unreachable device 200 later, direct wireless connection with this device 200 has already been established (or at least processing for direct wireless connection has already started). The user does not have to wait a long time before the mobile terminal 100 starts to communicate with the device 200.

In FIG. 11, in step S50, the monitor unit 114 determines whether a device A is located within the region 1, based on information concerning the estimated distance of the device A received from the Bluetooth module 130. If the result of step S50 is NO, the monitor unit 114 waits for receiving the next advertising packet from the device A and makes a determination in step S50 again.

If the result of step S50 is YES, the monitor unit 114 starts the pre-connection controller 118 in step S52. In step S54, the pre-connection controller 118 obtains the value indicating the reachability of the device A from the device monitor DB 122 and determines whether the value indicates YES (reachable).

If the device A is found to be reachable in step S54, the process proceeds to step S66. In step S66, the pre-connection controller 118 updates the value of the distance of the device A in the device monitor DB 122 to that received from the Bluetooth module 130 in step S50 and sets the value in the field “locating region” to “1”. The pre-connection controller 118 then terminates the processing.

If the device A is found to be unreachable in step S54, the process proceeds to step S56. In step S56, the pre-connection controller 118 starts the connecting device determining unit 120 and requests it to determine whether the device A will be selected as a connecting device. In this example, the connecting device determining unit 120 determines in step S58 whether the device A is located closest to the mobile terminal 100 among unreachable devices 200 within the region 1.

If the result of step S58 is NO, the process proceeds to step S66. In step S66, the connecting device determining unit 120 updates the value of the distance of the device A in the device monitor DB 122 to that received from the Bluetooth module 130 in step S50, and sets the closest distance flag to “NO” and the value in the field “locating region” to “1”. The connecting device determining unit 120 then terminates the processing.

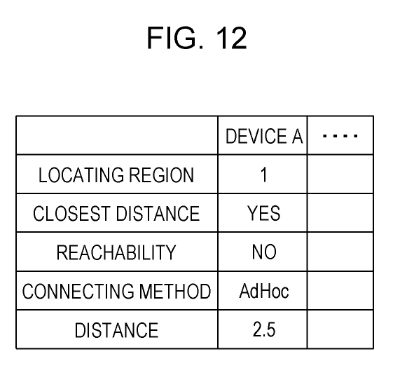

If the result of step S58 is YES, the pre-connection controller 118 selects the device A as a connecting device and executes processing for establishing direct wireless connection with the device A. That is, in step S60, the pre-connection controller 118 performs BLE communication with the device A. In step S62, the pre-connection controller 118 obtains profiles of printer connecting services from the GATT 212 of the device A. Then, in step S64, the pre-connection controller 118 tries the connecting methods indicated in the obtained printer connecting services in order of priority to establish direct wireless connection. Then, in step S66, the pre-connection controller 118 registers identification information concerning the direct wireless connecting method established in step S64 in the field “connecting method” of the device monitor DB 122. If ad hoc connection has been established with the device A in step S64, the data content of the entry for the device A in the device monitor DB 122 may be represented by that shown in FIG. 12. In this example, the device A is the closest distance device among the unreachable devices 200, and thus, the closest distance flag is set to be “YES”. Concerning the reachable device 200, the closest distance flag is left blank.

### Example of Standard for Determining Connecting Device

In the example shown in FIG. 8, the device 200 located within the region 1 and closest to the mobile terminal 100 is selected as a connecting device (step S36 in FIG. 8). In another example, the capabilities of devices 200 may be taken into account for determining a connecting device.

In this example, if plural devices 200 are located within the region 1, the device 200 that can execute processing requested by the user (that is, processing reflecting a function and processing parameters input into the UI 112 by the user in advance) is preferentially selected. For example, if the user specifies color printing on A3-size paper, among the devices 200 within the region 1, the device 200 that can perform color printing on A3-size paper is selected as a connecting device. If there are plural devices 200 within the region 1 that can execute processing requested by the user, a connecting device may be selected randomly or according to another standard (for example, whether a device 200 is a closest distance device).

This example will be explained in terms of the procedure shown in FIG. 8. Instead of making a determination in step S36 as to whether the device A is the closest distance device, the connecting device determining unit 120 determines whether the device A is capable of executing processing reflecting a function and processing parameters input by the user. More specifically, the connecting device determining unit 120 receives information concerning a printer performance service (see FIG. 5) and other performance services included in the GATT profile from the device A by BLE communication, and then determines whether the capabilities of the device A indicated by the information satisfy the function and processing parameters input by the user. If the result of this determination is YES, the device A is selected as a connecting device, and step S38 and the subsequent steps in FIG. 8 are executed.

As another example of the standard for determining a connecting device when plural devices 200 are located within the region 1, the connecting device determining unit 120 determines in step S36 whether, not only the device A, but also the other devices 200 within the region 1 have the capabilities that satisfy the function and processing parameters input by the user. Regarding reachable devices 200 within the region 1, the mobile terminal 100 obtains information concerning the capabilities of the reachable devices 200 by performing simple network management protocol (SNMP) communication with the IP addresses of the devices 200. If plural devices 200 including the device A are determined to be capable of executing processing requested by the user, the connecting device determining unit 120 selects a connecting device among the plural devices 200 by using another standard. If the device A is selected as a connecting device in step S36, step S38 and the subsequent steps in FIG. 8 are executed.

If there are no devices 200 within the region 1 that are capable of executing processing reflecting the function and processing parameters input by the user, a connecting device may not be selected from such devices 200. In this case, the device usage application 110 of the mobile terminal 100 may display a message on a screen that there is no nearby device 200 that can execute processing requested by the user.

### Another Example of Standard for Determining Connecting Device

In another example, when the connecting device determining unit 120 determines a connecting device 200, it may refer to an access history for devices 200 accessed by the mobile terminal 100.

In this example, every time the mobile terminal 100 uses (accesses) a certain device 200 (for example, the mobile terminal 100 sends a processing instruction to a device 200), it records identification information concerning the device 200 (for example, the IP address, SSID, or MAC address of the device 200 used for communicating with the device 200) and the access date in a history database (not shown). Then, if there are plural devices 200 within the region 1, the connecting device determining unit 120 preferentially selects a device 200 that has been used (that is, access to this device 200 is recorded in the history database) as a connecting device. If plural devices 200 within the region 1 are recorded in the history database, the connecting device determining unit 120 may select a device 200 that has been used most recently (access date is the latest). This example will be explained in terms of the procedure shown in FIG. 8. Instead of making a determination in step S36 as to whether the device A is the closest distance device, the connecting device determining unit 120 checks for a device 200 within the region 1 other than the device A. If there are no other devices 200 within the region 1, the connecting device determining unit 120 selects the device A as a connecting device. If there are other devices 200 within the region 1, the connecting device determining unit 120 checks the access history whether the access date for the device A is later than the access dates for the other devices 200. If the access date for the device A is the latest among the devices 200, the connecting device determining unit 120 selects the device A as a connecting device. If the access date for the device A is not the latest among the devices 200, it means that another device 200 has already been selected as a connecting device.

In another example, information concerning a device 200 that has been used most recently by the mobile terminal 100 is recorded in a history database. If a device 200 used most recently is detected within the region 1, it may be selected as a connecting device even if other devices 200 are located within the region 1.

Considering a situation, for example, where devices 200 are used in the office, the user usually wants to use a familiar device 200 among the plural devices 200 in the office. If the access history is used for selecting a connecting device, it is more likely that the device 200 that the user wants to use will be selected.

At least two of the above-described device selection standards, that is, those based on the distance from the mobile terminal 100 (the closest distance device 200 is selected), the capabilities of devices 200, and the access history, may be combined and used.

### First Example of Processing after Connecting Device is Determined

The process from when a connecting device 200 is determined until when the mobile terminal 100 establishes communication with the connecting device 200 via a network or by direct wireless connection has been discussed above.

After this process, the device 200 to be used by the user may be fixed as a result of the user performing a special operation.

In one example, the user fixes the device 200 as a device to be used by tapping the mobile terminal 100 on a NFC communication port (not shown) of the device 200. In this case, as a result of the mobile terminal 100 tapping the device 200, a NFC communication module of the mobile terminal 100 and that of the device 200 communicate with each other in accordance with the NFC standard. To perform this communication, information necessary for communicating with the device 200, for example, the IP address of the device 200 used for infrastructure connection and information for direct wireless connection (for example, SSID used for ad hoc connection and MAC address used for Wi-Fi Direct) is supplied from the device 200 to the mobile terminal 100. The mobile terminal 100 then sequentially checks whether connection has already been established (or processing for establishing connection is being executed) by using the connecting methods indicated by the information received from the device 200 by NFC communication. The mobile terminal 100 starts to communicate with the device 200 by using the connecting method by which connection has first been established (or processing for establishing connection is being executed).

Regarding the order of checking the connecting methods, the mobile terminal 100 first checks infrastructure connection (connection via a network). To check infrastructure connection, the mobile terminal 100 refers to the device monitor DB 122 and checks whether the device 200 indicated by the infrastructure-connection IP address received by NFC communication is reachable. If the device 200 is found to be reachable, the mobile terminal 100 communicates with the device 200 via a network by using this IP address, and then executes processing, such as sending a processing instruction and print data to the device 200 and receiving scanning result data from the device 200 by using the established communication channel. If infrastructure connection is not established (if, the device 200 is found to be unreachable), the mobile terminal 100 checks the direct wireless connecting methods in the same order of priority as that defined in the GATT profile (see FIG. 5). If a direct wireless connecting method for which connection has been established (or processing for establishing connection is being executed) is detected, the mobile terminal 100 communicates with the device 200 by using this direct wireless connecting method, and sends a processing instruction to the device 200.

If the user has already input information concerning a function to be used and processing parameters into the UI 112 when the device 200 to be used is fixed by NFC tapping, the mobile terminal 100 sends a processing instruction reflecting this information and information necessary for performing the processing (for example, print data in the case of a print instruction) to the device 200. The device 200 performs processing in accordance with the received instruction and information.

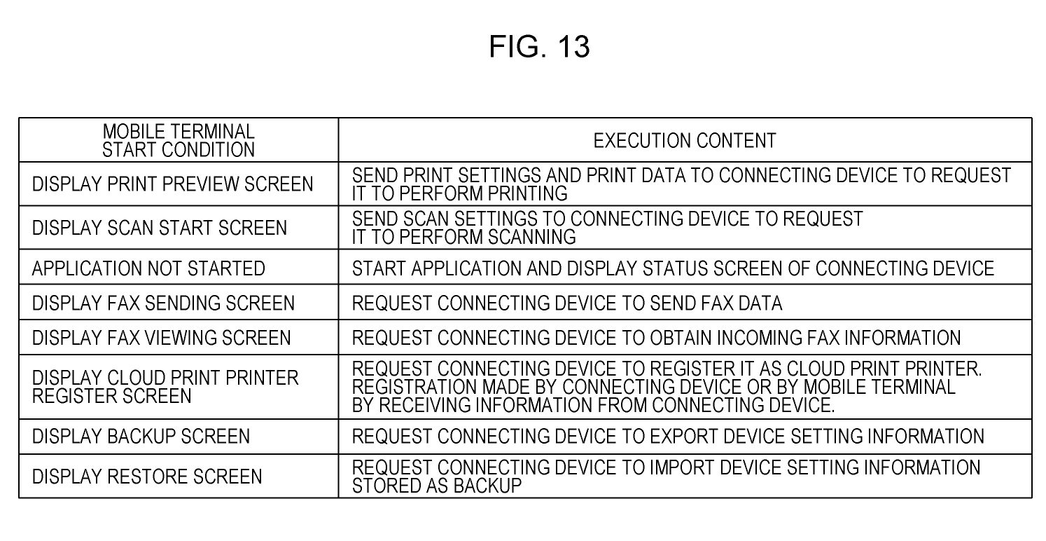

FIG. 13 illustrates examples of conditions for starting the mobile terminal 100 and the content of processing executed by the mobile terminal 100 for the device 200 when a certain condition for starting the mobile terminal 100 is satisfied. The condition for starting the mobile terminal 100 is displayed on the screen by the UI 112 when the device 200 to be used is fixed (for example, when NFC tapping is performed). The content displayed on the screen reflects the state of the UI 112, that is, the content of information input into the UI 112 by the user (function and processing parameters selected by the user).

In the examples shown in FIG. 13, if a print preview screen is displayed on the mobile terminal 100 when the user taps the mobile terminal 100 on the device 200, the mobile terminal 100 sends print data concerning a document and print settings indicated by the print preview screen to the device 200 and requests it to perform printing. That is, if a print preview screen is displayed on the mobile terminal 100, it means that the user has already selected a document to be printed and input print settings by using the UI 112. Thus, upon detecting that NFC tapping is performed, the mobile terminal 100 sends a print command including the print data concerning this document and the print settings to the device 200. The print command is sent to the device 200 as a result of the user tapping the mobile terminal 100 on the device 200. That is, the user does not have to press a print start button displayed on the print preview screen. The device 200 then prints the received print data in response to the request.

If a scan start screen (including a scan start button) is displayed on the mobile terminal 100 when the user taps the mobile terminal 100 on the device 200, it means that the user has already input scan settings into the UI 112. The mobile terminal 100 then sends a scan processing request including information concerning scan settings to the device 200.

As described above, the user can fix the device 200 to be used by tapping the mobile terminal 100 on the NFC communication port of the device 200. However, NFC tapping is only an example, and the device 200 may be fixed by another approach.

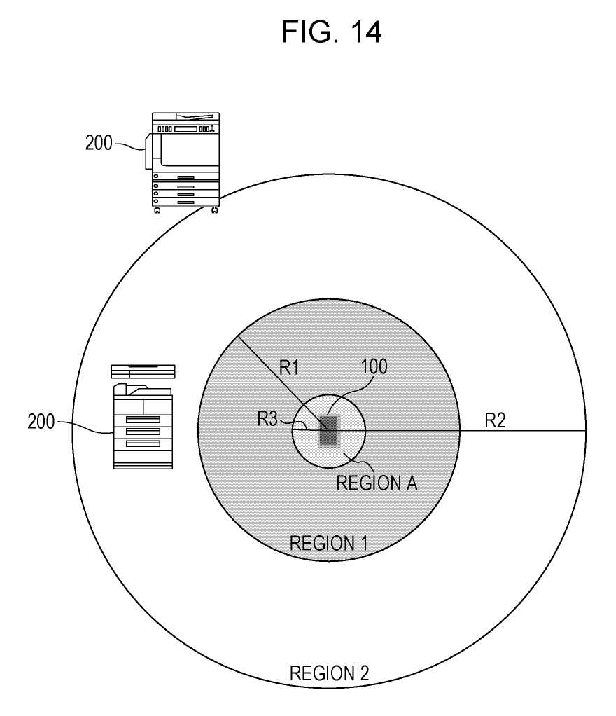

In another example, as shown in FIG. 14, a region A is set farther inward than the region 1 (see FIG. 1), which is used for determining a connecting device. Upon detecting a device 200 located within the region A, the mobile terminal 100 determines that this device 200 will be used by the user. The size of the region A is set so that the user holding the mobile terminal 100 can reach the device 200 located in the region A, for example, the region A with a radius R3 of about 0.5 m.

Upon detecting a device 200 located within the region A from the monitoring result of the monitor unit 114, the mobile terminal 100 determines that this device 200 will be used by the user, and then performs processing similar to that after NFC tapping is performed.

### Second Example of Processing after Connecting Device is Determined

After a device 200 is fixed as a device to be used by a user as discussed in the first example of processing after a connecting device is determined, the user may be guided to this device 200.

This example will be explained in terms of the procedure shown in FIG. 8. After the connecting device determining unit 120 has selected a device 200 as a connecting device in step S36 according to the standard based on the distance from the mobile terminal 100 (closest distance device 200 is selected) or based on the capabilities of the devices 200 or the access history for devices 200), the mobile terminal 100 performs processing for guiding the user to the connecting device 200.

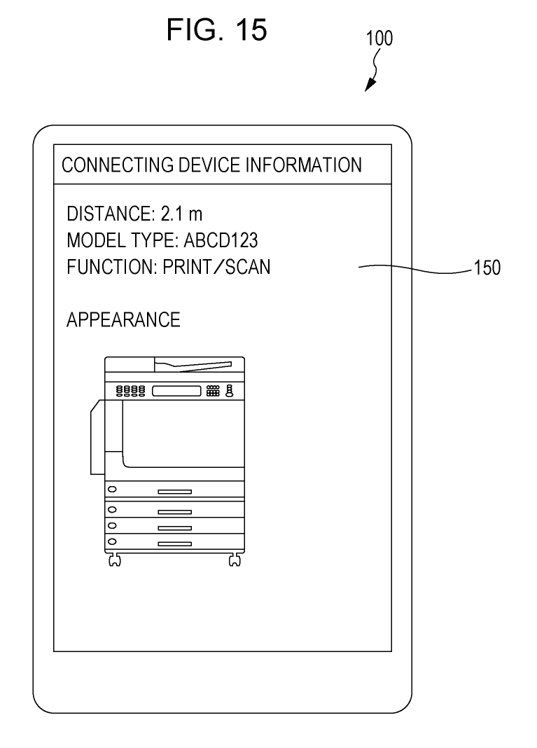

For example, as shown in FIG. 15, the mobile terminal 100 may guide the user by displaying information concerning the device 200 selected as a connecting device on a screen 150 of the mobile terminal 100. In the example shown in FIG. 15, the distance from the mobile terminal 100 to the device 200, the model type of the device 200, the functions (printing and scanning) provided by the device 200, and the external appearance image of the device 200 are displayed as information for guiding the user. Information concerning the model type, functions, and external appearance image is obtained from the device 200 selected as a connecting device. If the device 200 is reachable from the mobile terminal 100, the above-described information concerning the device 200 is obtained via a network. If the device 200 is unreachable, the information is obtained by established direct wireless connection.

The user may be guided in a different manner. For example, the device 200 selected as a connecting device may perform a predetermined informing operation for informing the user that the device 200 is a connecting device. For example, the device 200 may cause a lamp provided in the device 200 or the operation panel 230 to emit light in a special pattern, for example, by causing the lamp to be ON or blink or the operation panel 230 to blink. After selecting the device 200 as a connecting device, the mobile terminal 100 sends a request to perform such an informing operation to this device 200, and the device 200 performs a predetermined informing operation in response to the request.

As another example of the informing operation, the device 200 may display information that the device 200 is a connecting device on the operation panel 230, such as a message “Mr. XX, printing is starting”. In this case, part of information (for example, the user name (Mr. XX) in this message) or the entire information to be displayed on the display panel 230 may be supplied from the mobile terminal 100 (device usage application 110) to the device 200.

As another example of the informing operation, a special sound (for example, beeping sound) may be output from a speaker (not shown) provided in the device 200.

The above-described informing operations performed by the device 200 are only examples. The device 200 may perform another informing operation or perform a combination of two or more of the above-described informing operations.

The guiding operation performed by the mobile terminal 100 (displaying connecting device information) and the guiding operation performed by the device 200 (various informing operations) may be combined and performed.

The above-described guiding operations are not performed if the device usage application 110 is not being executed (active) in the mobile terminal 100. The user does not necessarily wish to use a device 200 while the device usage application 110 is being executed. Then, the above-described guiding operations may be performed only when the UI 112 of the device usage application 110 receives a certain operation reflecting a user's intention to use a device 200 from the user. Examples of a certain operation reflecting a user's intention to use a device 200 are inputting of a function to be used (such as printing and scanning) and processing parameters into the UI 112 and displaying of a screen regarding the condition for starting the mobile terminal 100 (such as a print preview screen) shown in FIG. 13.

When a device 200 is selected as a connecting device, the mobile terminal 100 may perform the above-described guiding operation and also send information concerning a request (function to be used and processing parameters) input into the UI 112 by the user to the device 200. In this case, the device 200 may immediately start processing based on the information received from the mobile terminal 100. Alternatively, the device 200 may not immediately start processing, but store the information received from the mobile terminal 100. In this case, the device 200 may start processing based on the information in response to the execution of a NFC tap operation or upon detecting that the device 200 enters the region A (see FIG. 14) discussed in the first example of processing after a connecting device is determined.

### Prioritizing of Reachable Device

If a reachable device 200 is located within the region 1, it may be selected as a connecting device, and direct wireless connection with unreachable devices 200 within the region 1 may not be established.

This example will be explained in terms of the procedure shown in FIG. 11. If a certain device 200 is found within the region 1 in step S50, the mobile terminal 100 determines whether the device 200 is reachable in step S54 and records the determination result in the device monitor DB 122. If the mobile terminal 100 determines in step S54 that the device 200 is unreachable, it refers to the device monitor DB 122 to check for a reachable device 200 within the region 1. If a reachable device 200 located within the region 1 is found, the mobile terminal 100 terminates the processing without executing step S58 and the subsequent steps. If the device 200 is found to be unreachable in step S54 and there is no reachable device 200 within the region 1, the mobile terminal 100 executes step S58 and the subsequent steps.

In this modified example, a guiding operation for guiding the user to the device 200 selected as a connecting device may be performed in a manner similar to that discussed in the second example of processing after a connecting device is determined.

### Starting to Determine Connecting Device in Response to Special Operation

In the above-described example, processing for specifying a connecting device of the mobile terminal 100 is started (triggered) in response to a device 200 entering the region 1.

As another example, processing for specifying a connecting device of the mobile terminal 100 may be started (triggered) in response to a user performing a special operation on the mobile terminal 100.

A special operation for starting (triggering) processing for specifying a connecting device is an operation which reflects a user's intention to use a device 200.

An example of the special operation is inputting of an instruction concerning the use of a device 200 (such as selecting of a function to be used) into the UI 112 of the device usage application 110 by the user. Tapping of the mobile terminal 100 on the NFC communication port of a device 200 is another example of the special operation. If the tapped device 200 is a device 200 supporting the device usage application 110, information received by the NFC communication module of the device 200 is sent to the device usage application 110, thereby enabling the device usage application 110 to detect that a special operation has been performed.

Starting of the device usage application 110 may be an example of the special operation for triggering processing for specifying a connecting device. In this case, however, the network reachability of a device 200 has to be checked in advance (that is, before this device 200 is specified as a connecting device) before the device usage application 110 is started. To satisfy this condition, among the elements shown in FIG. 2, at least the monitor unit 114, the pre-connection determining unit 116, and the device monitor DB 122 are implemented as a program or elements outside the device usage application 110 (for example, they are built in an operating system) so that they can be executed even when the device usage application 110 is inactive. This suggests that the monitor unit 114, the pre-connection determining unit 116, and the device monitor DB 122 may not be necessarily implemented as functions of the device usage application 110, as those shown in FIG. 2. Instead, these elements may be implemented as a program different from the device usage application 110. The pre-connection controller 118 and the connecting device determining unit 120 may also be implemented as another program. This also applies to an example in which processing for specifying a connecting device of the mobile terminal 100 is started (triggered) in response to a device 200 entering the region 1.

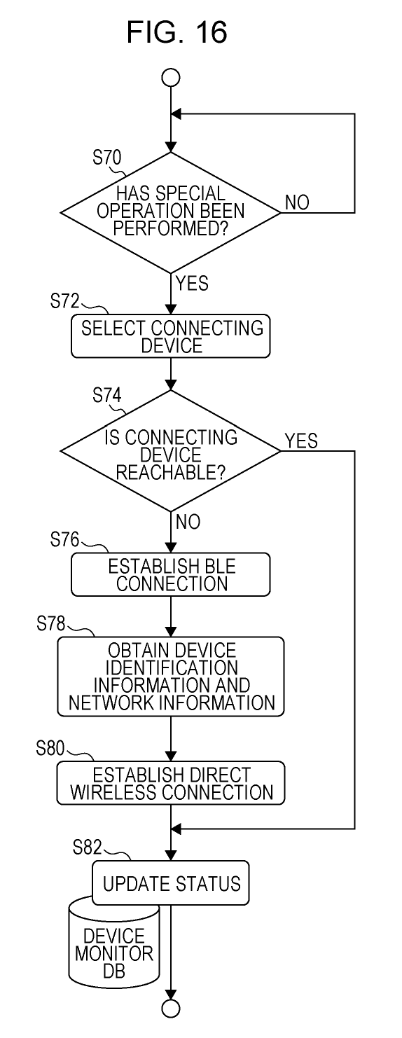

If a connecting device is specified in response to a user performing a special operation on the mobile terminal 100, processing shown in FIG. 16 is executed, instead of that in FIG. 8 or 11 for specifying a connecting device in response to a device 200 entering the region 1. The processing shown in FIG. 16 is based on the condition that a determination of the network reachability of a device shown in FIG. 6 has already been performed.

In FIG. 16, in step S70, the pre-connection controller 118 regularly checks whether a user has performed the above-described special operation on the mobile terminal 100. If the user performs the special operation, the pre-connection controller 118 causes the connecting device determining unit 120 to determine a connecting device in step S72. The connecting device determining unit 120 may select a device 200 according to the standard based on the distance from the mobile terminal 100 estimated by BLE (closest distance device 200 is selected). Alternatively, the connecting device determining unit 120 may select a device 200 according to one of the above-described standards, such as that based on the capabilities of devices 200 and that based on the access history for devices 200. Alternatively, the connecting device determining unit 120 may select a device 200 according to a combination of at least two of the above-described standards. If the special operation found in step S70 is an operation for tapping the mobile terminal 100 on the device 200, the tapped device 200 is selected as a connecting device 200.

Then, in step S74, the pre-connection controller 118 determines whether the selected device 200 is reachable. If the device 200 is found to be reachable, the pre-connection controller 118 updates the status of the device 200 in the device monitor DB 122 in step S82 by skipping processing for establishing direct wireless connection. The pre-connection controller 118 then terminates the processing. If the device 200 is found to be unreachable, the pre-connection controller 118 performs BLE connection with the device 200 in step S76. Then, in step S78, the pre-connection controller 118 obtains profiles of printer connecting services from the GATT 212 of the device 200. In step S80, the pre-connection controller 118 tries the connecting methods indicated in the obtained printer connecting services in order of priority to establish direct wireless connection. In step S82, the pre-connection controller 118 registers identification information concerning the established direction wireless connecting method in the device monitor DB 122. Then, the processing has been completed.

After the device 200 has been selected in step S72, the device usage application 110 may perform processing for guiding the user to the device 200. The guiding processing may be one of the above-described guiding operations such as displaying of information concerning the connecting device 200 and instructing the device 200 to perform an informing operation, for example, causing the screen of the connecting device 200 to blink or outputting sound, as discussed in the second example of processing after a connecting device is determined. Along with this guiding processing, information concerning processing requested by the user (for example, print data) may be sent to the connecting device 200.

The information processing modules of the mobile terminal 100 and the device 200 are implemented by causing a computer to execute a program representing the functions of the mobile terminal 100 and the device 200. The computer has a hardware circuit configuration in which a microprocessor, such as a central processing unit (CPU), memory devices (primary storage devices), such as a random access memory (RAM) and a read only memory (ROM), a controller for controlling solid-state storage devices, such as a flash memory, a solid state drive (SSD), and a hard disk drive (HDD), various input/output (I/O) interfaces, a network interface for controlling connection with a network, such as a LAN, are connected to one another via a bus, for example. A program describing the processing content of the above-described functions is stored in a solid-state storage device, such as a flash memory, via a network, and is installed into the computer. As a result of reading the program stored in the solid-state storage device into the RAM and executing the program by the microprocessor, such as a CPU, the above-described functional modules are implemented.

The foregoing description of the exemplary embodiment of the present invention has been provided for the purposes of illustration and description. It is not intended to be exhaustive or to limit the invention to the precise forms disclosed. Obviously, many modifications and variations will be apparent to practitioners skilled in the art. The embodiment was chosen and described in order to best explain the principles of the invention and its practical applications, thereby enabling others skilled in the art to understand the invention for various embodiments and with the various modifications as are suited to the particular use contemplated. It is intended that the scope of the invention be defined by the following claims and their equivalents.

What is claimed is:

1. An information processing apparatus comprising:
an obtaining unit that obtains addresses of individual devices in a network from the devices;
a trying unit that tries to communicate to the addresses of the devices via the network and stores trying results;
a specifying unit that specifies a device as a connecting device from among the devices; and
a connecting unit that connects to the connecting device by using a connecting method which is specified based on the trying result concerning the connecting device.

2. The information processing apparatus according to claim 1, wherein:
the obtaining unit receives the addresses from the individual devices by wireless communication; and
the specifying unit specifies a device as the connecting device from among devices located within a first region, the first region being positioned farther inward than a communication range of the wireless communication as viewed from the information processing apparatus.

3. The information processing apparatus according to claim 1, wherein the specifying unit specifies a device as the connecting device when a user performs a specific operation which reflects an intention of the user to use a device.

4. The information processing apparatus according to claim 1, wherein the specifying unit specifies a device located closest to the information processing apparatus as the connecting device.

5. The information processing apparatus according to claim 4, wherein, if the trying result concerning the device located closest to the information processing apparatus indicates that the device is reachable from the information processing apparatus via the network, the connecting unit establishes direct wireless connection with a device located closest to the information processing apparatus among devices that are found, based on the trying results, to be unreachable from the information processing apparatus via the network.

6. The information processing apparatus according to claim 1, further comprising:
a receiving unit that receives input of a processing instruction,
wherein the specifying unit specifies a device as the connecting device from among devices that are capable of executing the input processing instruction.

7. The information processing apparatus according to claim 1, further comprising:
a memory that stores an access history for devices accessed from the information processing apparatus,
wherein the specifying unit preferentially specifies, as the connecting device, a device which is found to be accessed most recently based on the access history.

8. The information processing apparatus according to claim 2, wherein, if at least one reachable device which is found, based on the trying result, to be reachable from the information processing apparatus via the network and at least one unreachable device which is found, based on the trying result, to be unreachable from the information processing apparatus via the network are located within the first region, the specifying unit specifies a device as the connecting device from among the at least one reachable device.

9. The information processing apparatus according to claim 1, further comprising:
a guiding processor that executes processing for guiding a user to the connecting device.

10. The information processing apparatus according to claim 9, further comprising:
a receiving unit that receives input of a processing instruction; and
a sending unit that sends the processing instruction which has been received by the receiving unit to the connecting device.

11. The information processing apparatus according to claim 2, further comprising:
a receiving unit that receives input of a processing instruction; and
a sending unit that sends the processing instruction which has been received by the receiving unit to the connecting device when the connecting device enters an adjacent region, the adjacent region being located farther inward than the first region as viewed from the information processing apparatus.

12. The information processing apparatus according to claim 1, further comprising:
a receiving unit that receives input of a processing instruction; and
a sending unit that sends the processing instruction which has been received by the receiving unit to the connecting device when the connecting device is detected by near field communication.

13. An information processing method comprising:
obtaining addresses of individual devices in a network from the devices;
trying to communicate to the addresses of the devices via the network and storing trying results;
specifying a device as a connecting device from among the devices; and
connecting to the connecting device by using a connecting method which is specified based on the trying result concerning the connecting device.

14. A non-transitory computer readable medium storing a program causing a computer to execute a process, the process comprising:
obtaining addresses of individual devices in a network from the devices;
trying to communicate to the addresses of the devices via the network and storing trying results;
specifying a device as a connecting device from among the devices; and
connecting to the connecting device by using a connecting method which is specified based on the trying result concerning the connecting device.
